(19) United States
(12) Patent Application Publication
(10) Pub. No.: US 2026/0139751 A1
(43) Pub. Date: May 21, 2026

(54) FAUCET AND INSTALLATION STRUCTURE OF VALVE SEAT THEREOF

(71) Applicant: Xiamen Lota International Co., Ltd., Xiamen (CN)

(72) Inventors: Qiang HUANG, Xiamen (CN); Chenglong LIN, Xiamen (CN); Aihui ZHANG, Xiamen (CN); Chuanbao ZHU, Xiamen (CN)

(21) Appl. No.: 19/247,048

(22) Filed: Jun. 24, 2025

(30) Foreign Application Priority Data
Nov. 20, 2024 (CN) 202422831518.1

(51) Int. Cl. F16K 11/00; E03C 1/02

(52) U.S. Cl. CPC F16K 19/006; E03C 2001/026

(57) ABSTRACT

An installation structure of a valve seat of a faucet includes the valve seat, a first adapter, and a second adapter. The valve seat is configured to be selectively connected to the first adapter or the second adapter. The valve seat includes an insertion port. The first adapter and the second adapter respectively includes a first insertion head and a second insertion head. The first insertion head or the second insertion head is configured to be selectively connected to the insertion port by insertion to enable the valve seat to be selectively connected to the first adapter or the second adapter. The first adapter includes a first protrusion. The second adapter includes a second protrusion. A height of the first protrusion is smaller than a height of the second protrusion, so that the first adapter and the second adapter are configured to be respectively matched with different three-way pipes.

### RELATED APPLICATIONS

This application claims priority to Chinese patent application number 202422831518.1, filed on November 20, 2024. Chinese patent application number 202422831518.1 is incorporated herein by reference.

### FIELD OF THE DISCLOSURE

The present disclosure relates to a faucet and an installation structure of a valve seat thereof.

### BACKGROUND OF THE DISCLOSURE

In a basic structure of a faucet, the faucet primarily comprises a housing and a valve seat. The housing is typically a cylindrical structure with openings to be connected to connecting components, such as water pipes. The valve seat, installed inside the housing, is a critical component for controlling a turning on and off a water flow. The valve seat is usually equipped with sealing rings to prevent water leakage and ensure smooth operation of an on/off mechanism of the faucet. Depending on usage requirements, different types of faucets may comprises hot and cold water inlet/outlet ports, and a structure and positioning of the valve seat will vary accordingly to adapt to different water flow control modes.

However, the current issue is as follows. Due to variations in the shape and size of housings across different faucet designs, the valve seat must undergo structural adjustments to accommodate the specific geometry and spatial layout of the housing. This means that each unique housing design requires a correspondingly customized valve seat to ensure proper installation and functional compatibility. This necessity not only increases design and production costs, but also complicates faucet installation and maintenance. Furthermore, frequent customization exacerbates inventory management challenges and results in poor versatility of faucet components.

### BRIEF SUMMARY OF THE DISCLOSURE

The technical problem to be solved by the present disclosure is to provide a faucet and an installation structure of a valve seat thereof.

In order to solve the above technical problems, the present disclosure provides an installation structure of a valve seat of a faucet comprising the valve seat, a first adapter, and a second adapter. The valve seat is configured to be selectively connected to the first adapter or the second adapter, and the valve seat comprises an insertion port. The first adapter and the second adapter respectively comprises a first insertion head and a second insertion head. The first insertion head or the second insertion head is configured to be selectively connected to the insertion port by insertion to enable the valve seat to be selectively connected to the first adapter or the second adapter. The first adapter comprises a first protrusion, and the second adapter comprises a second protrusion. A height of the first protrusion is smaller than a height of the second protrusion, so that the first adapter and the second adapter are configured to be respectively matched with different three-way pipes.

In a preferred embodiment, the valve seat is selectively connected to the first adapter or the second adapter, so that the valve seat is configured to be respectively adapted to a first three-way pipe of the different three-way pipes and a second three-way pipe of the different three-way pipes. The first three-way pipe comprises a first mounting groove, and the first adapter is inserted into the valve seat to form a first mounting structure. The first mounting structure is configured to be installed from a bottom opening of the first mounting groove so that the first protrusion abuts a top wall of the first mounting groove. The second three-way pipe comprises a second mounting groove and a positioning groove located above the second mounting groove, and the second adapter is inserted into the valve seat to form a second mounting structure. The second mounting structure is configured to be installed from a bottom opening of the second mounting groove so that the second insertion head abuts a top wall of the second mounting groove and the second protrusion is inserted into the positioning groove.

In a preferred embodiment, the first insertion head or the second insertion head is hermetically connected to the insertion port through one or more sealing rings disposed between the insertion port and the first insertion head or the second insertion head.

In a preferred embodiment, the first three-way pipe and the second three-way pipe respectively comprises a first lateral opening and a second lateral opening, and the valve seat comprises a connecting surface corresponding to the first lateral opening or the second lateral opening. A pressing cover is configured to be connected to the first lateral opening or the second lateral opening to press and secure the connecting surface.

In a preferred embodiment, the first three-way pipe comprises a through groove located above the first mounting groove, and a first water nozzle assembly is configured to be inserted into the through groove. A first water outlet pipe is configured to pass through the first water nozzle assembly and be inserted into the first protrusion.

In a preferred embodiment, an upper side of the through groove is connected to the first water nozzle assembly through one or more retaining springs, and a lower side of the through groove is connected to the first water nozzle assembly through a screw. A distal end of the first water outlet pipe is connected to a lower end of the first water nozzle assembly through a first retaining ring.

In a preferred embodiment, a second water nozzle assembly is configured to be sleeved on the second three-way pipe, and a second water outlet pipe is configured to pass through the second water nozzle assembly and be inserted into the second protrusion.

The present disclosure provides a faucet comprising the installation structure of the valve seat of the faucet.

Compared with the existing techniques, the technical solution has the following advantages.

The installation structure of the valve seat of the faucet comprises the valve seat, the first adapter, and the second adapter. The valve seat is configured to be selectively connected to the first adapter or the second adapter, and the valve seat comprises the insertion port. The first adapter and the second adapter respectively comprises the first insertion head and the second insertion head. The first insertion head or the second insertion head is configured to be selectively connected to the insertion port by insertion to enable the valve seat to be selectively connected to the first adapter or the second adapter. The first adapter comprises the first protrusion, and the second adapter comprises the second protrusion. The height of the first protrusion is smaller than the height of the second protrusion, so that the first adapter and the second adapter are configured to be respectively matched with different three-way pipes.

### BRIEF DESCRIPTION OF THE DRAWINGS

FIG. 1 is a perspective view of a connection between a valve seat and a first three-way pipe in the preferred embodiment of the present disclosure.

FIG. 2 is an exploded view of the connection between the valve seat and the first three-way pipe in the preferred embodiment of the present disclosure.

FIG. 3 is an exploded view of the valve seat and a first adapter in the preferred embodiment of the present disclosure.

FIG. 4 is a cross-sectional view of a connection between the valve seat and the first three-way pipe in the preferred embodiment of the present disclosure.

FIG. 5 is a perspective view of a connection between the valve seat and a second three-way pipe in the preferred embodiment of the present disclosure.

FIG. 6 is an exploded view of the connection between the valve seat and the second three-way pipe in the preferred embodiment of the present disclosure.

FIG. 7 is a cross-sectional view of the connection between the valve seat and the second three-way pipe in the preferred embodiment of the present disclosure.

### DETAILED DESCRIPTION OF THE EMBODIMENTS

The present disclosure is further described below in conjunction with the accompanying drawings and specific embodiments.

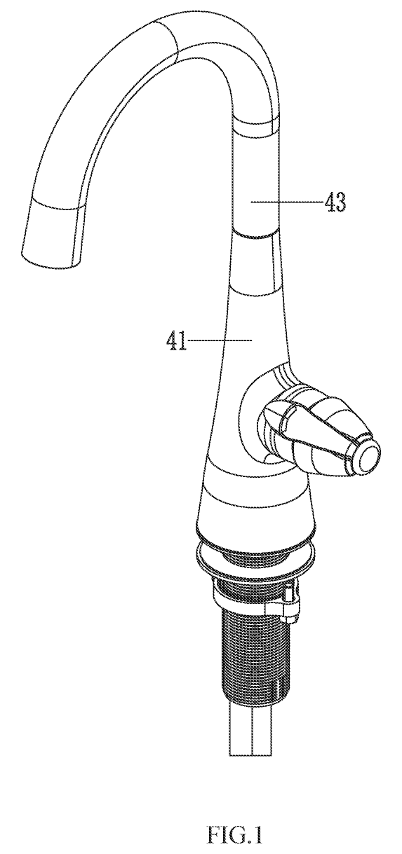

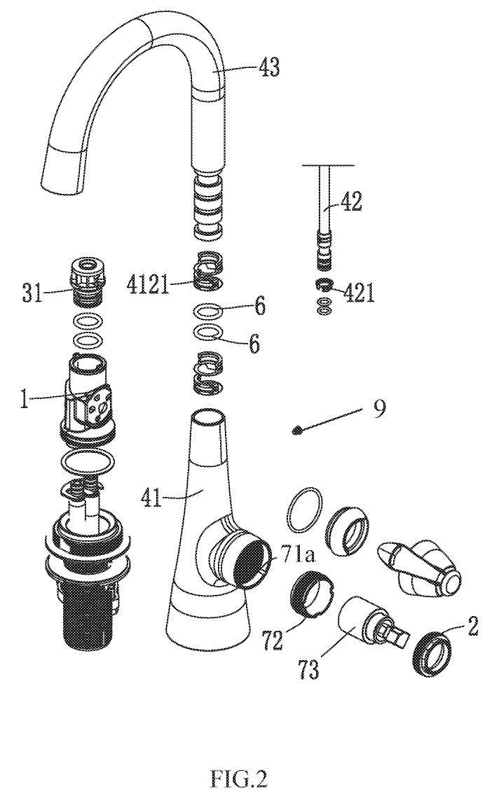

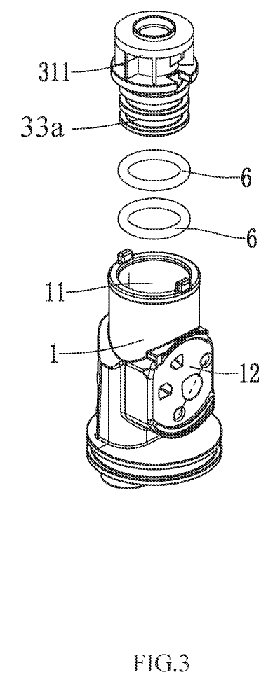

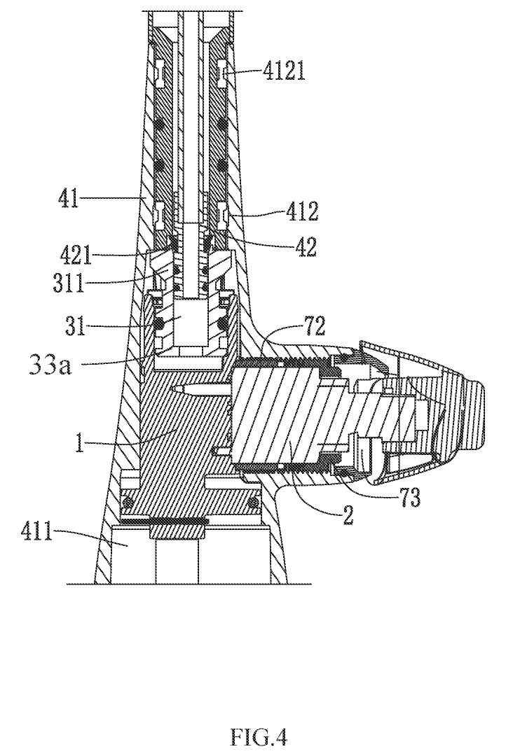

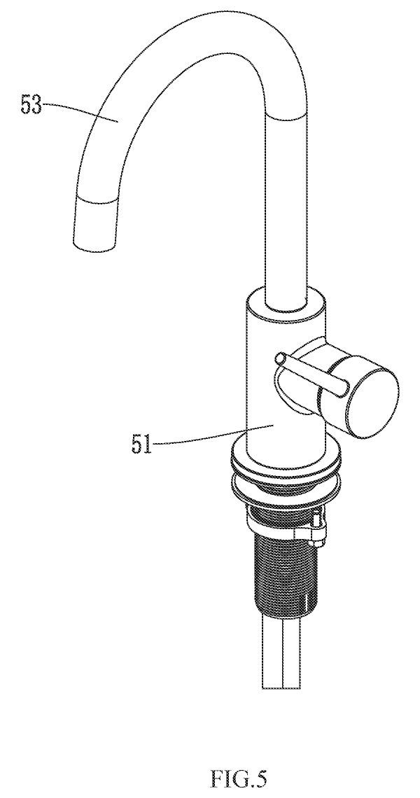

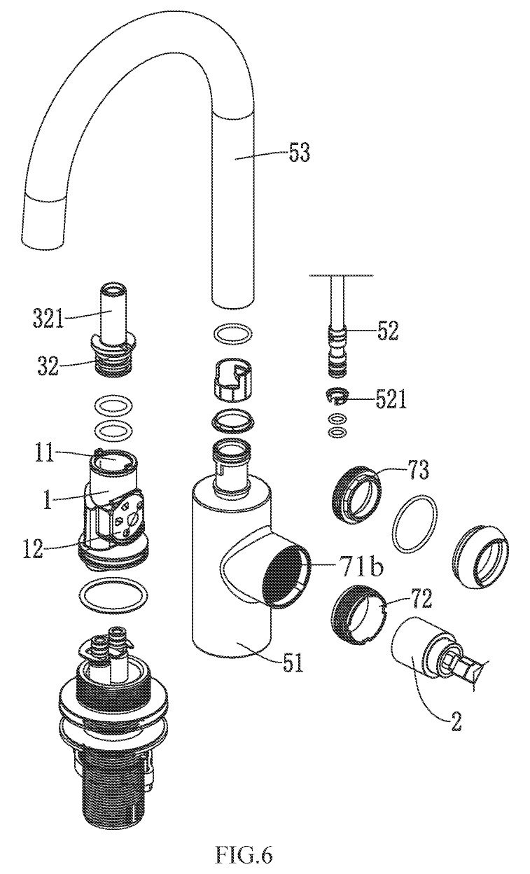

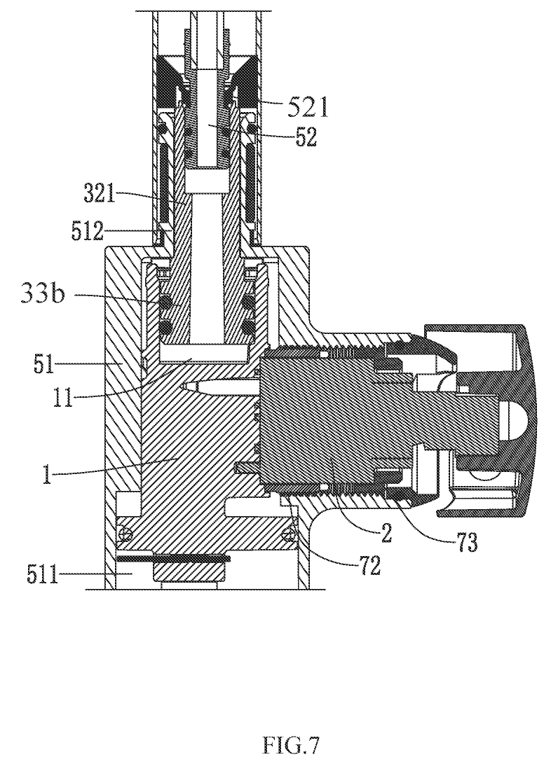

Referring to FIGS. 1-7, a faucet comprises a valve seat 1, a valve 2, a first adapter 31, a second adapter 32, a first three-way pipe 41, and a second three-way pipe 51. The valve seat 1 can be selectively connected to the first adapter 31 or the second adapter 32. The valve seat 1 comprises an insertion port 11, and the first adapter 31 and the second adapter 32 respectively comprises a first insertion head 33a and a second insertion head 33b. The first insertion head 33a or the second insertion head 33b can be selectively inserted into the insertion port 11 to enable the valve seat 1 to be selectively connected to the first adapter 31 or the second adapter 32.

The first adapter 31 comprises a first protrusion 311, and the second adapter 32 includes a second protrusion 321. A height of the first protrusion 311 is smaller than a height of the second protrusion 321, so that the first adapter 31 and the second adapter 32 can respectively match with the first three-way pipe 41 and the second three-way pipe 51.

The first three-way pipe 41 comprises a first mounting groove 411, and the first adapter 31 is inserted into the valve seat 1 to form a first mounting structure. The first mounting structure can be installed from a bottom opening of the first mounting groove 411 so that the first protrusion 311 abuts a top wall of the first mounting groove 411.

The second three-way pipe 51 comprises a second mounting groove 511 and a positioning groove 512 located above the second mounting groove 511. The second adapter 32 is inserted into the valve seat 1 to form a second mounting structure. The second mounting structure can be installed from a bottom opening of the second mounting groove 511 so that the second insertion head 33b abuts a top wall of the second mounting groove 511 and the second protrusion 321 is inserted into the positioning groove 512.

The first adapter 31 or the second adapter 32 is selectively connected to the valve seat 1, so that the valve seat 1 can be adapted to the first three-way pipe 41 or the second three-way pipe 51.

In this embodiment, the first insertion head 33a or the second insertion head 33b is hermetically connected to the insertion port 11 through one or more sealing rings 6 disposed between the insertion port 11 and the first insertion head 33a or the second insertion head 33b.

In this embodiment, the first three-way pipe 41 and the second three-way pipe 51 respectively comprises a first lateral opening 71a and a second lateral opening 71b. The valve seat 1 comprises a connecting surface 12 corresponding to the first lateral opening 71a or the second lateral opening 71b. A pressing cover 72 can be connected to the first lateral opening 71a or the second lateral opening 71b to press and secure the connecting surface 12. The valve 2 can be installed from the first lateral opening 71a or the second lateral opening 71b to be connected to the connecting surface 12, and the faucet further comprises an upper cover 73, which is fixedly connected to the first lateral opening 71a or the second lateral opening 71b to press and secure the valve 2.

The first three-way pipe 41 comprises a through groove 412 located above the first mounting groove 411. A first water nozzle assembly 43 can be inserted into the through groove 412, and a first water outlet pipe 42 can pass through the first water nozzle assembly 43 and be inserted into the first protrusion 311. An upper side of the through groove 412 is connected to the first water nozzle assembly 43 through one or more retaining springs 4121, and a lower side of the through groove 412 is connected to the first water nozzle assembly 43 through a screw. A distal end of the first water outlet pipe 42 is connected to a lower end of the first water nozzle assembly 43 through a first retaining ring 421. The lower end of the first water nozzle assembly 43 is inserted into the through groove 412, and the one or more retaining springs 4121 are sleeved on the upper side of the through groove 412. The one or more retaining springs 4121 are C-shaped and sleeved on the lower end of the first water nozzle assembly 43, and the one or more retaining springs 4121 can press outward against a groove wall of the through groove 412.

For the first three-way pipe 41, the one or more sealing rings 6 are firstly sleeved on the first adapter 31, and then the first insertion head 33a is inserted into the insertion port 11 to form the first mounting structure. The first mounting structure is installed from the bottom opening of the first mounting groove 411 so that the first protrusion 311 abuts the top wall of the first mounting groove 411. At this time, the pressing cover 72 is installed from the first lateral opening 71a to press and secure the valve seat 1, and the valve 2 and the upper cover 73 are then installed on the first three-way pipe 41. The first water outlet pipe 42 passes through an upper end of the first water nozzle assembly 43 until the first water outlet pipe 42 passes through the lower end of the first water nozzle assembly 43. The first retaining ring 421 is disposed between the distal end of the first water outlet pipe 42 and the lower end of the first water nozzle assembly 43 to achieve a connection between the first water outlet pipe 42 and the first water nozzle assembly 43. Then, the first water nozzle assembly 43 and the first water outlet pipe 42 are connected together to an upper end of the first three-way pipe 41, so that the first water outlet pipe 42 is correspondingly inserted into the first protrusion 311, and the first water nozzle assembly 43 is correspondingly inserted into the through groove 412, and finally locked by screws.

A second water nozzle assembly 53 can be sleeved on the second three-way pipe 51, and a second water outlet pipe 52 can pass through the second water nozzle assembly 53 and be inserted into the second protrusion 321. A distal end of the second water outlet pipe 52 is connected to a lower end of the second water nozzle assembly 53 through a second retaining ring 521.

For the second three-way pipe 51, the one or more sealing rings 6 are first sleeved on the second adapter 32, and then the second insertion head 33b is inserted into the insertion port 11 to form the second mounting structure. The second mounting structure is installed from the bottom opening of the second mounting groove 511 so that the second insertion head 33b abuts the top wall of the second mounting groove 511 and the second protrusion 321 is inserted into the positioning groove 512. At this time, the pressing cover 72 is installed from the second lateral opening 71b and presses and secures the valve seat 1. The valve 2 and the upper cover 73 are then installed on the second three-way pipe 51. The second water outlet pipe 52 passes through an upper end of the second water nozzle assembly 53 until the second water outlet pipe 52 passes through the lower end of the second water nozzle assembly 53, and the second retaining ring 521 is disposed between the distal end of the second water outlet pipe 52 and the lower end of the second water nozzle assembly 53 to achieve a connection between the second water outlet pipe 52 and the second water nozzle assembly 53. Then, the second water nozzle assembly 53 and the second water outlet pipe 52 are connected together to an upper end of the second three-way pipe 51, so that the second water outlet pipe 52 is correspondingly inserted into the second protrusion 321 and the second water nozzle assembly 53 is correspondingly sleeved on the upper end of the second three-way pipe 51. Finally, the second water nozzle assembly 53 is buckled to the second three-way pipe 51.

The above is only a preferred specific implementation method of the present disclosure, but the design concept of the present disclosure is not limited to this. Any technician familiar with the technical field who uses this concept to make non-substantial changes to the present disclosure within the technical scope disclosed by the present disclosure shall be deemed to infringe the protection scope of the present disclosure.

What is claimed is:

1. An installation structure of a valve seat of a faucet, comprising:
the valve seat,
a first adapter, and
a second adapter, wherein:
the valve seat is configured to be selectively connected to the first adapter or the second adapter,
the valve seat comprises an insertion port,
the first adapter and the second adapter respectively comprises a first insertion head and a second insertion head,
the first insertion head or the second insertion head is configured to be selectively connected to the insertion port by insertion to enable the valve seat to be selectively connected to the first adapter or the second adapter,
the first adapter comprises a first protrusion,
the second adapter comprises a second protrusion, and
a height of the first protrusion is smaller than a height of the second protrusion, so that the first adapter and the second adapter are configured to be respectively matched with different three-way pipes.

2. The installation structure of the valve seat of the faucet according to claim 1, wherein:
the valve seat is selectively connected to the first adapter or the second adapter, so that the valve seat is configured to be respectively adapted to a first three-way pipe of the different three-way pipes or a second three-way pipe of the different three-way pipes,
the first three-way pipe comprises a first mounting groove,
the first adapter is inserted into the valve seat to form a first mounting structure,
the first mounting structure is configured to be installed from a bottom opening of the first mounting groove so that the first protrusion abuts a top wall of the first mounting groove,
the second three-way pipe comprises a second mounting groove and a positioning groove located above the second mounting groove,
the second adapter is inserted into the valve seat to form a second mounting structure, and
the second mounting structure is configured to be installed from a bottom opening of the second mounting groove so that the second insertion head abuts a top wall of the second mounting groove and the second protrusion is inserted into the positioning groove.

3. The installation structure of the valve seat of the faucet according to claim 2, wherein:
the first insertion head or the second insertion head is hermetically connected to the insertion port through one or more sealing rings disposed between the insertion port and the first insertion head or the second insertion head.

4. The installation structure of the valve seat of the faucet according to claim 2, wherein:
the first three-way pipe and the second three-way pipe respectively comprises a first lateral opening and a second lateral opening,
the valve seat comprises a connecting surface corresponding to the first lateral opening or the second lateral opening, and
a pressing cover is configured to be connected to the first lateral opening or the second lateral opening to press and secure the connecting surface.

5. The installation structure of the valve seat of the faucet according to claim 2, wherein:
the first three-way pipe comprises a through groove located above the first mounting groove,
a first water nozzle assembly is configured to be inserted into the through groove, and
a first water outlet pipe is configured to pass through the first water nozzle assembly and be inserted into the first protrusion.

6. The installation structure of the valve seat of the faucet according to claim 5, wherein:
an upper side of the through groove is connected to the first water nozzle assembly through one or more retaining springs,
a lower side of the through groove is connected to the first water nozzle assembly through a screw, and
a distal end of the first water outlet pipe is connected to a lower end of the first water nozzle assembly through a first retaining ring.

7. The installation structure of the valve seat of the faucet according to claim 2, wherein:
a second water nozzle assembly is configured to be sleeved on the second three-way pipe, and
a second water outlet pipe is configured to pass through the second water nozzle assembly and be inserted into the second protrusion.

8. A faucet, comprising the installation structure of the valve seat of the faucet according to claim 1.

9. A faucet, comprising the installation structure of the valve seat of the faucet according to claim 2.

10. A faucet, comprising the installation structure of the valve seat of the faucet according to claim 3.

11. A faucet, comprising the installation structure of the valve seat of the faucet according to claim 4.

12. A faucet, comprising the installation structure of the valve seat of the faucet according to claim 5.

13. A faucet, comprising the installation structure of the valve seat of the faucet according to claim 6.

14. A faucet, comprising the installation structure of the valve seat of the faucet according to claim 7.
